(19) United States
(12) Patent Application Publication
(10) Pub. No.: US 2011/0067021 A1
(43) Pub. Date: Mar. 17, 2011

(54) ELECTRONIC DEVICE AND METHOD OF UPDATING SOFTWARE THEREOF

(75) Inventor: HORNG-JUING LEE, Tu-Cheng (TW)

(73) Assignee: HON HAI PRECISION INDUSTRY CO., LTD., Tu-Cheng (TW)

(21) Appl. No.: 12/645,310

(22) Filed: Dec. 22, 2009

(30) Foreign Application Priority Data
Sep. 17, 2009 (CN) 200910307189.8

(51) Int. Cl. G06F 9/44

(52) U.S. Cl. 717/171

(57) ABSTRACT

An electronic device connects to a server to update software. The electronic device includes an execution module, a download module and an installation module. The execution module determines whether a new update schedule is available on the server according to an update schedule. The download module downloads the new software package according to the update schedule when a new software package is detected. The installation module installs the new software package.

### BACKGROUND

1. Technical Field

The present disclosure relates to electronic devices, and particularly to an electronic device and a method of updating software on the electronic device.

2. Description of Related Art

Electronic devices (such as a digital photo frame) often require updated firmware/software from a server, on which a new version of software for the electronic device is available. However, when multiple downloads are active at the same time, server resources can be overworked.

### BRIEF DESCRIPTION OF THE DRAWINGS

FIG. 1 shows a schematic view of a plurality of electronic devices connecting with a server in accordance with one embodiment.

FIG. 2 is a block diagram of the electronic device and the server of FIG. 1.

FIG. 3 is a schematic view of an embodiment of an update schedule with a week period.

FIG. 4 is a schematic view of an update schedule with a day period.

FIG. 5 is a flowchart of an embodiment of a method for updating software for an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

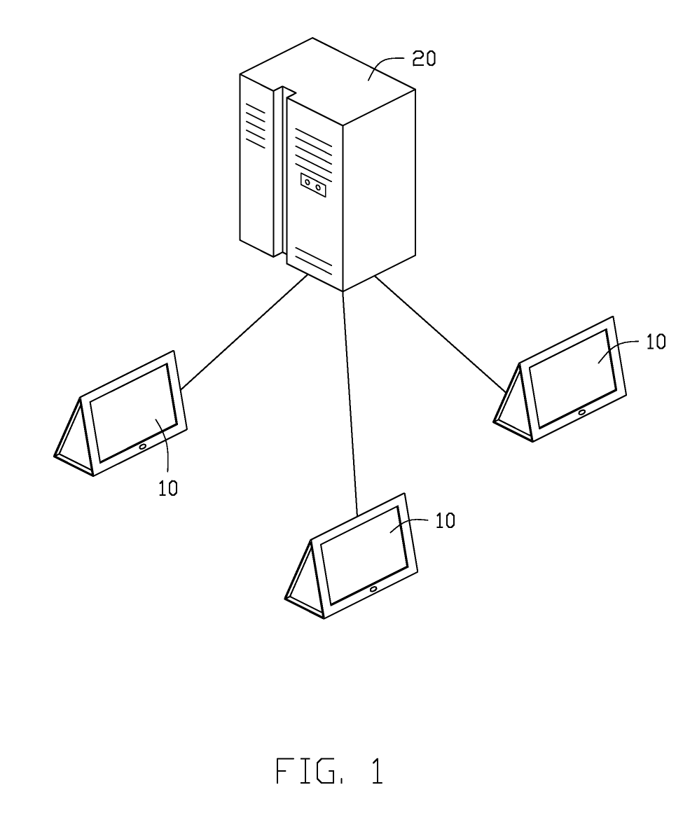

Referring to FIG. 1, a plurality of electronic devices 10 connects with a server 20 through a network. Each electronic device 10 acquires a software package from the server 20 to update software/firmware. The electronic device 10 may be a digital photo frame, a media player, personal computer, or other device.

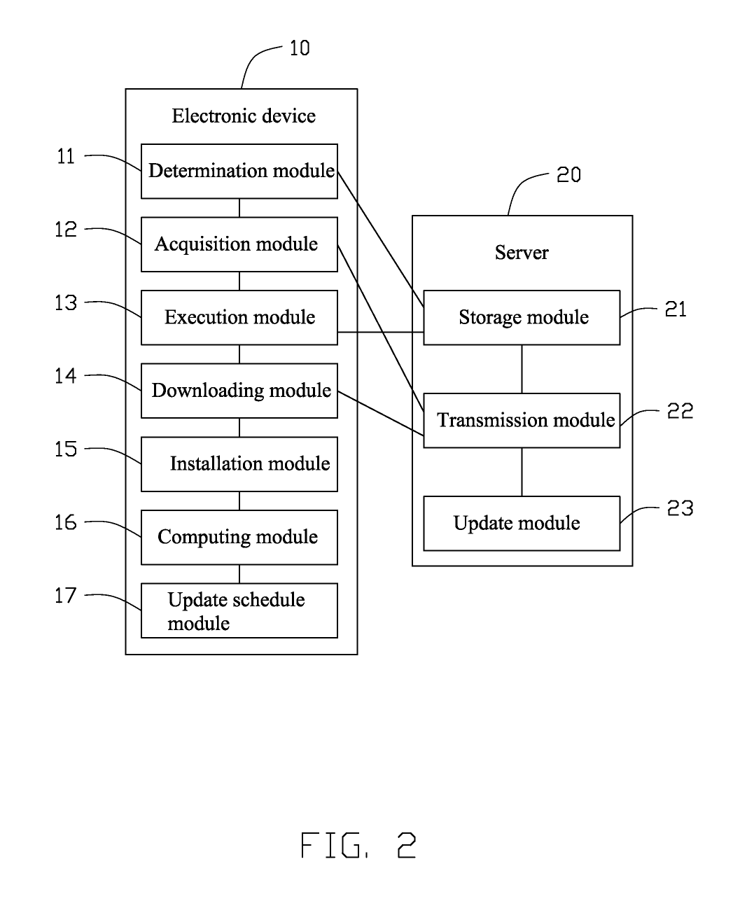

Referring to FIG. 2, the electronic device 10 can download the software package from the server 20 according to an update schedule. The electronic device 10 includes a determination module 11, an acquisition module 12, an execution module 13, a download module 14, an installation module 15, a computing module 16 and an update schedule module 17.

The update schedule module 17 stores the update schedule comprising a plurality of update time slots and a unique device number corresponding to each update time slot. The determination module 11 checks for new update schedules on the server 20 according to the update schedule. The acquisition module 12 acquires new update schedules from the server 20 when available. The execution module 13 determines whether there is a new software package according to the update schedule. If so, the download module 14 downloads the new software package from the server 20. The installation module 15 installs the new software package to update the electronic device 10. The computing module 16 computes and outputs the unique device number of the electronic device 10.

The server 20 includes a storage module 21, a transmission module 22 and an update module 23. The update module 23 updates the update schedule automatically or on demand. The storage module 21 stores the new update schedule and the new software package. The transmission module 22 transmits the new update schedule and the new software package to the electronic device 10.

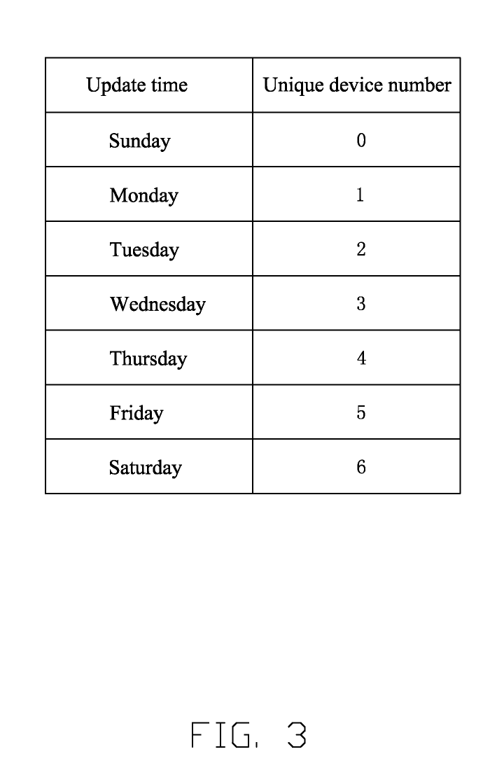

Referring to FIG. 3, the electronic device 10 includes a unique device identification number. The computing module 16 computes the unique device identification number into the unique device number. The unique device identification number includes a product serial number, a media access control (MAC) address, and a globally unique identifier code.

The update schedule module includes n update time slots. The unique device identification number is translated into a decimal value and then divided by n to get a remainder being the unique device number. For example, the remainder is 1 when 7 is divided by 3. In FIG. 3, seven days of a week is a period. The electronic device 10 having the remainder 0 updates on Sunday, 1 updates on Monday, 2 updates on Tuesday, and so on.

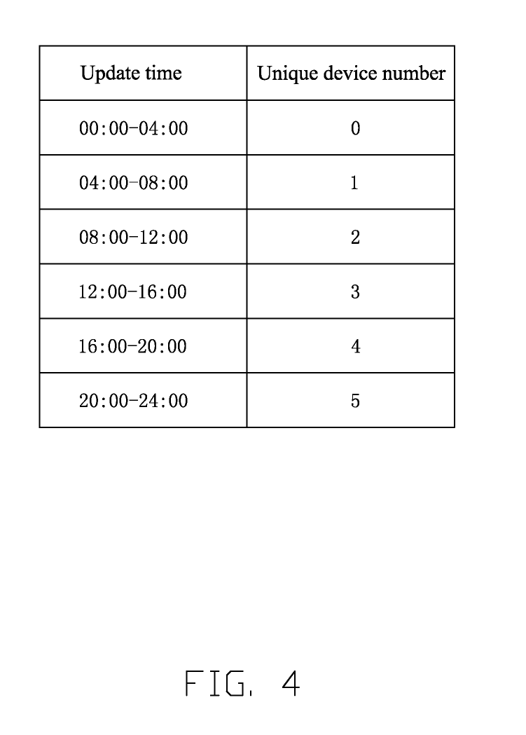

When a day is divided into six periods, the computing module 16 computes the unique device identification number divided by six to get the remainder. For example, in FIG. 4, the electronic device 10 having the remainder 0 updates from 00:00 to 04:00, 1 updates from 04:00 to 08:00, 2 updates from 08:00 to 12:00, and so on.

In the disclosure, the electronic devices 10 are divided into several groups. Each group of electronic devices 10 updates at the different times, reducing peak resource requirement of the server 20.

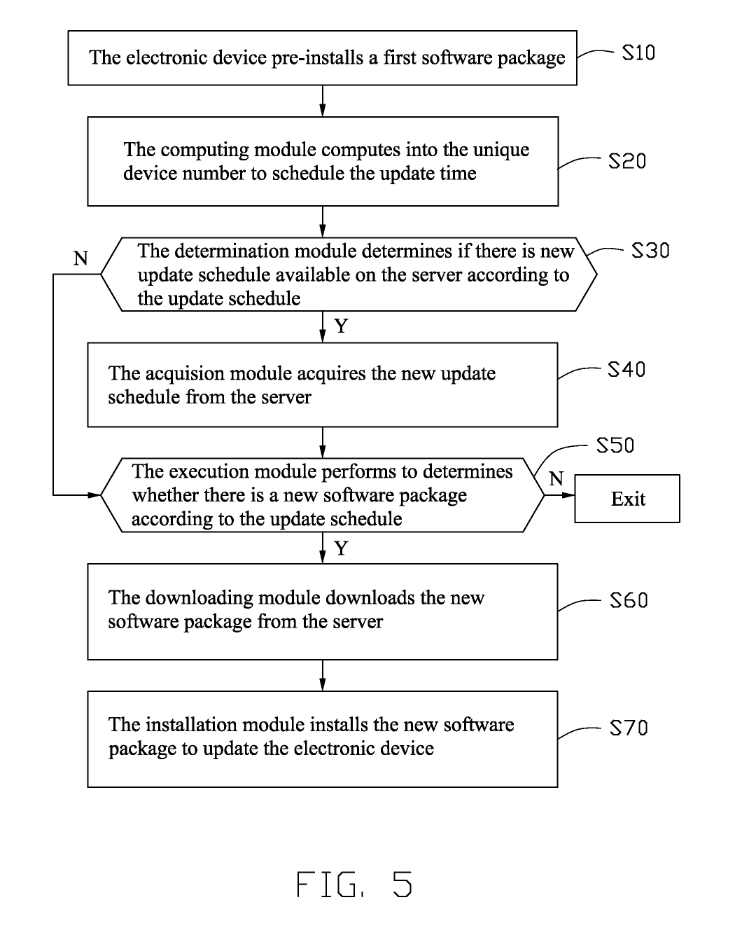

FIG. 5 a software update method for an electronic device is shown.

In block S10, the electronic device 10 pre-installs a first software package.

In block S20, the computing module 16 computes the unique device number of the electronic device 10 and uses the unique device number to schedule the update time.

In block S30, the determination module 11 determines if there is a new update schedule available on the server 20 according to the update schedule. If so, S40 is implemented; if not, S50 is implemented.

In block S40, the acquisition module 12 acquires the new update schedule from the server 20.

In block S50, the execution module 13 determines whether there is a new software package according to the update schedule. If so, S60 is implemented; If not, the procedure terminates.

In block S60, the download module 14 downloads the new software package from the server 20.

In block S70, the installation module 15 installs the new software package to update the electronic device 10 after download is complete.

The server 20 can set update levels, for example, within a day (critical), a month (high), or normal schedule (regular). The update schedule module 17 partitions the update requests to follow systematic schedule to smooth out the requests over time which in turn reduces peak resource requirement.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic device comprising:
an execution module capable of determining whether a new software package exists on a server according to an update schedule;
a download module capable of downloading the new software package according to the update schedule when the new software package is detected;
an installation module capable of installing the new software package.

2. The electronic device of claim 1, further comprising a unique device identification number and a computing module capable of translating the unique device identification number into a unique device number.

3. The electronic device of claim 2, wherein the update schedule, stored in an update schedule module, defines an update time slot and the unique device number; and the download module is capable of downloading the new software package according to the update time slot.

4. The electronic device of claim 2, wherein the update schedule comprises n update time slots, a decimal value is equal to the unique device identification number, the unique device number is equal to a remainder of the decimal value divided by n via a computing module.

5. The electronic device of claim 2, wherein the unique device identification number comprises a product serial number and a globally unique identifier.

6. The electronic device of claim 1, further comprising a determination module capable of determining whether a new update schedule is available on the server.

7. The electronic device of claim 1, further comprising an acquisition module capable of acquiring a new update schedule from the server.

8. The electronic device of claim 1, wherein the update schedule defines a plurality of update levels to update the new software package at different times.

9. The electronic device of claim 1, wherein the electronic device is capable of handling an update request on demand to update the software package.

10. The electronic device of claim 1, wherein the electronic device is capable of pre-installing a first update schedule.

11. A method of updating electronic device software, the method comprising:
determining whether a new software package exists on a server by an execution module according to an update schedule;
downloading a new software package via a download module according to the update schedule;
installing the new software package via an installation module.

12. The method of claim 11, wherein the electronic device comprises a unique device identification number and a computing module translates the unique device identification number into a unique device number.

13. The method of claim 12, wherein the update schedule comprises an update time slot and the unique device number, and the download module downloads the new software package according to the update time slot.

14. The method of claim 12, wherein the update schedule comprises n update time slots, a decimal value is equal to the unique device identification number, the unique device number is equal to a remainder of the decimal value divided by n via a computing module.

15. The method of claim 12, wherein the unique device identification number comprises a product serial number and a globally unique identifier (GUID).

16. The method of claim 11, wherein the electronic device comprises a determination module capable of determining whether a new update schedule is available on the server.

17. The method of claim 11, wherein the electronic device comprises an acquisition module capable of acquiring a new update schedule from the server to update the update schedule.

18. The method of claim 11, wherein the update schedule defines a plurality of update levels to update the new software package at different times.

19. The method of claim 11, wherein the electronic device first responds to an update request on demand to update the software package.

20. The method of claim 11, wherein the electronic device pre-installs a first update schedule.
